(19) United States
(12) Patent Application Publication
(10) Pub. No.: US 2015/0002780 A1
(43) Pub. Date: Jan. 1, 2015

(54) LIQUID CRYSTAL PANEL AND LIQUID CRYSTAL DISPLAY DEVICE

(71) Applicants: HON HAI PRECISION INDUSTRY CO., LTD., New Taipei (TW); FU TAI HUA INDUSTRY (SHENZHEN) CO., LTD., Shenzhen (CN)

(72) Inventors: LI-CHIN LU, New Taipei (TW); XUE MOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/951,419

(22) Filed: Jul. 25, 2013

(30) Foreign Application Priority Data
Jun. 28, 2013 (CN) 2013102660340

(51) Int. Cl. G02F 1/1333

(52) U.S. Cl. CPC G02F 1/133308
USPC 349/60

(57) ABSTRACT

A liquid crystal panel includes a main body and a number of fixing members. The main body includes two opposite sidewalls. The fixing members protrude from the opposite sidewalls of the main body. Each fixing member includes an elastic portion extending from one opposite sidewall and a hole portion extending from an end of the elastic portion away from the main body.

### BACKGROUND

1. Technical Field

The present disclosure relates to liquid crystal display devices, and particularly to a liquid crystal panel and a liquid display device using the liquid crystal panel.

2. Description of Related Art

A conventional liquid crystal panel defines a number of screw holes to allow the liquid crystal panel to be fixed to a frame of a liquid crystal display device by screws. However, if the screws are applied too tightly, the liquid crystal panel will be deformed, which can cause light leakages.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a front view of a liquid crystal display device, in accordance with an exemplary embodiment.

FIG. 2 is an isometric view of a liquid crystal panel of the liquid crystal display device of FIG. 1, in accordance with an exemplary embodiment.

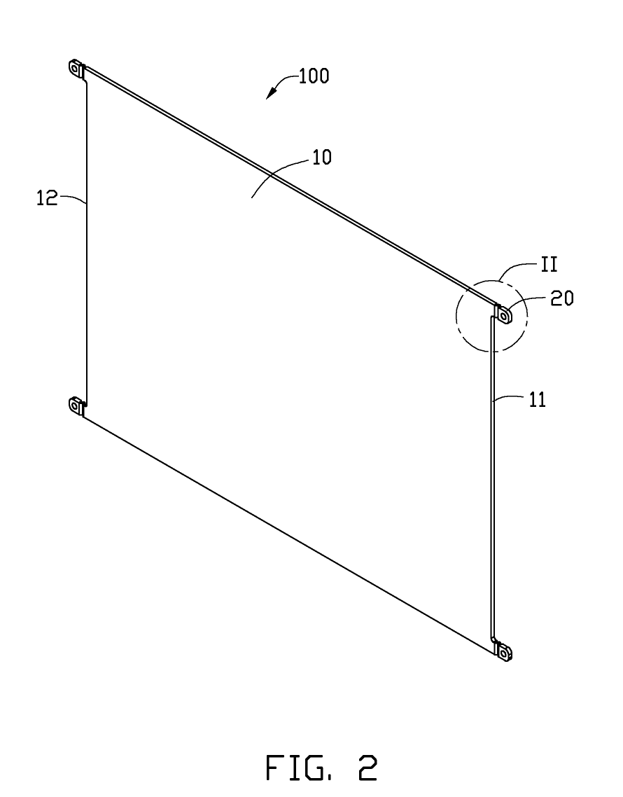

FIG. 3 is an enlarged, perspective view of a circled portion II-II of FIG. 1.

### DETAILED DESCRIPTION

Embodiments of the present disclosure will now be described in detail, with reference to the accompanying drawings.

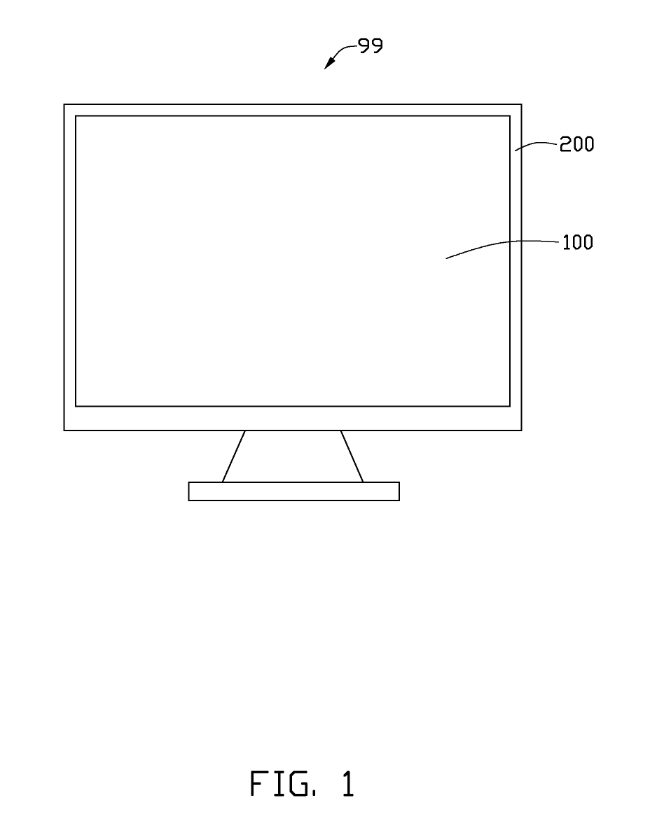

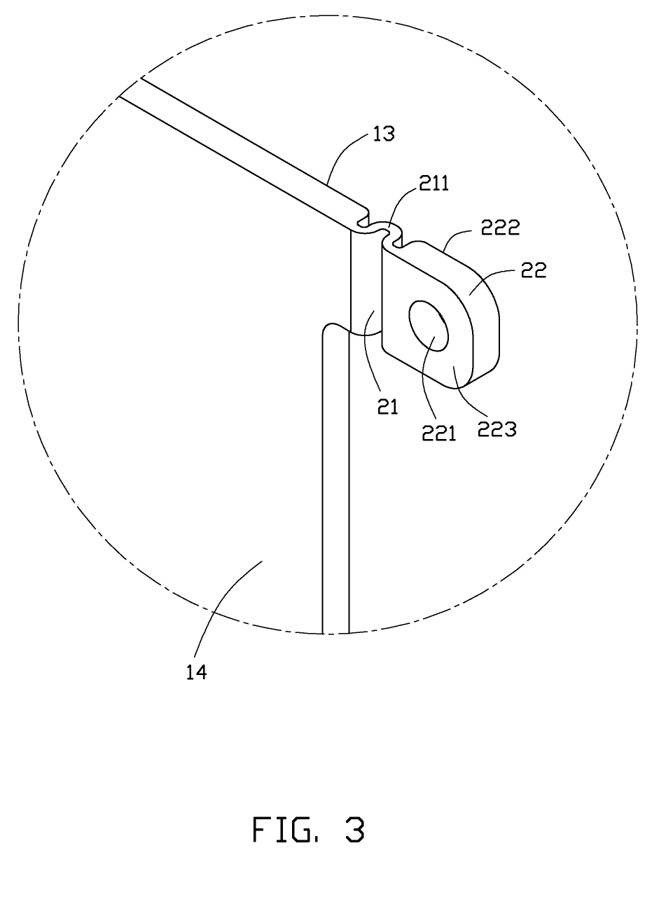

Referring to FIGS. 1 and 3, an embodiment of a liquid crystal display device 99 includes a liquid crystal panel 100 and a frame 200 secured to the liquid crystal panel 100. The liquid crystal panel 100 includes a main body 10 and four fixing members 20. The four fixing members 20 is to fix the liquid crystal panel 100 to the frame 200. The main body 10 is used to display the visual information. The main body 10 includes two opposite sidewalls 11, 12, a back surface 13, and a front surface 14. The front surface 14 is opposite to the back surface 13 and used to display the visual information. Each two fixing members 20 protrude from one of the opposite sidewalls 11, 12. In this embodiment, each fixing member 20 is arranged on an end of one of the opposite sidewalls 11, 12.

In this embodiment, each fixing member 20 includes an elastic portion 21 and a hole portion 22. The elastic portion 21 extends from one sidewall 11 or 12 of the main body 10. The hole portion 22 extends from an end of the elastic portion 21 away from the main body 10. The hole portion 22 defines a hole 221 to allow a fixing element (e.g. a screw) to extend through. The elastic portion 21 includes a protruding portion 211. A top end of the protruding portion 211 is aligned with the back surface 13 of the main body 10 and a bottom surface 222 of the hole portion 22. A top surface 223 of the hole portion 22 is aligned with the front surface 14 of the main body 10. In this embodiment, the protruding portion 211 is inverted-C shaped.

With such configuration, by using the elastic portions 21, assembling the liquid crystal panel 100 to the frame 200 of the liquid crystal display device 99 will not cause the deformation of the liquid crystal panel 100, thus light leakage is accordingly avoided.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A liquid crystal panel comprising:
a main body comprising two opposite sidewalls; and
a plurality of fixing members protruding from the opposite sidewalls of the main body, wherein, each of the fixing members comprises an elastic portion extending from one of the opposite sidewalls and a hole portion extending from an end of the elastic portion away from the main body.

2. The liquid crystal panel as described in claim 1, wherein each of the elastic portions comprises a protruding portion, the main body comprises a front surface to display visual information and a back surface opposite to the front surface, a top end of the protruding portion is aligned with the back surface of the main body.

3. The liquid crystal panel as described in claim 2, wherein the top end of the protruding portion is further aligned with a bottom surface of the hole portion.

4. The liquid crystal panel as described in claim 1, wherein the protruding portion is inverted C-shaped.

5. The liquid crystal panel as described in claim 2, wherein a top surface of the hole portion is aligned with the front surface of the main body.

6. The liquid crystal panel as described in claim 1, wherein the liquid crystal panel comprises four fixing members, each two of the four fixing members protrudes from one of the two opposite sidewalls of the main body.

7. A liquid crystal display device comprising:
a liquid crystal panel comprising:
a main body comprising two opposite sidewalls; and
a plurality of fixing members protruding from the opposite sidewalls of the main body, wherein, each of the fixing members comprises an elastic portion extending from one of the opposite sidewalls and a hole portion extending from an end of the elastic portion away from the main body.

8. The liquid crystal display device as described in claim 7, wherein each of the elastic portions comprises a protruding portion, the main body comprises a front surface to display visual information and a back surface opposite to the front surface, a top end of the protruding portion is aligned with the back surface of the main body.

9. The liquid crystal display device as described in claim 8, wherein the top end of the protruding portion is further aligned with a bottom surface of the hole portion.

10. The liquid crystal display device as described in claim 7, wherein the protruding portion is inverted C-shaped.

11. The liquid crystal display device as described in claim 8, wherein a top surface of the hole portion is aligned with the front surface of the main body.

12. The liquid crystal display device as described in claim 7, wherein the liquid crystal panel comprises four fixing members, each two of the four fixing members protrudes from one of the two opposite sidewalls of the main body.
